(19) United States
(12) Patent Application Publication
(10) Pub. No.: US 2012/0071609 A1
(43) Pub. Date: Mar. 22, 2012

(54) Dew and Rain Harvesting with Superabsorbent Polymers

(76) Inventor: Manilal J. Savla, Manalapan, NJ (US)

(21) Appl. No.: 13/231,664

(22) Filed: Sep. 13, 2011

Related U.S. Application Data
(60) Provisional application No. 61/403,737, filed on Sep. 21, 2010.

(51) Int. Cl. C08F 20/06; C08F 20/56; C08G 63/44

(52) U.S. Cl. 525/329.4; 525/55; 528/362; 525/329.7

(57) ABSTRACT

A method for harnessing rain and dew water with superabsorbent polymers. Highly absorbent superabsorbent polymers which are stimuli-responsive are used to absorb rain/dew water to augment water supply and solve water crisis. The polymers may be recycled and rehydrated number of times. They may be an additional source for drinking water. The polymers are used for storage of water in warehouses and the invention may obviate the need to construct controversial huge dams and canals or drill wells. The stored water in superabsorbent polymers is released at the point of use by any stimulus which may be mechanical, light-induced, electrical, thermal treatment or chemical treatment. Superabsorbent polymers with absorbing power of at least 1000 times their own weight are preferred. With 2000 g/g of swelling capacity, we can have 99.95% pure water in solid/gel form. In solid form, water can be transported anywhere without leakage.

### CROSS-REFERENCE TO RELATED APPLICATIONS

Provisional patent application No. 61/403,737 dated Sep. 21, 2010

### BACKGROUND OF THE INVENTION

1. Field

This invention relates to use of superabsorbent polymers for harvesting and storage of dew and rain water.

2. Prior Art

Superabsorbent polymers (SAP) are polymers that can absorb and retain extremely large amounts of a liquid relative to its own mass. Lightly cross-linked sodium polyacrylate is the most common type of SAP made in the world today. Widely used in personal disposable hygiene products such as baby diapers, it can absorb about 800 times its weight of distilled water. Other SAP compositions include acrylamide copolymers, ethylene maleic anhydride copolymers, crosslinked carboxy-methyl-cellulose, polyvinyl alcohol copolymers, crosslinked polyethylene oxide and starch grafted copolymer of acrylonitrile.

One of the early patents, U.S. Pat No. 3,669,103, describes compositions based on lightly cross-linked polymers, such as polyvinylpyrrolidones, sulfonated polystyrenes, sulfonated polyvinyltoluenes, poly-sulfoethyl acrylates, poly-2-hydroxyethyl acrylates, polyacrylates, hydrolyzed polyacrylamides and copolymers of acrylamide with acrylic acid for use in diapers.

U.S. Pat No. 3,935,099 describes alkali saponified gelatinized-starch-polyacrylonitrile graft polymers used as absorbents for aqueous suspensions such as sewage sludge.

U.S. Pat. No. 4,286,082 discloses lightly cross-linked sodium polyacrylate SAP for use in baby diapers and sanitary napkins

In U.S. Pat. No. 4,483,950, starch-based superabsorbents extended with modified starches were promoted as thickening agents.

U.S. Pat. No. 4,913,517 covers uses of SAPs as cable-sealing materials.

U.S. Pat. No. 5,241,009 describes polycarboxyl group containing superabsorbents wherein neutralization of said carboxyl groups with potassium or lithium is described as providing a polymeric composition specifically adapted to absorb proteinaceous fluids, such as blood.

U.S. Pat. No. 6,800,712 discloses SAPs based on grafted starches for use in crop production.

In all above examples, SAPs generally absorb up to 1000 times their weight of water.

Global demand for SAPs approaches 2 million metric tons annually. More than 90% is used in disposable hygiene products. Small amounts are used in agriculture, cable sealing and other niche applications.

Recent research has resulted in some highly absorbent SAPs . Deyu in his Ph.D. thesis “Superabsorbent Polymer Composite Materials and their Industrial and High-Tech Applications”, 2003, at Technische Universitat, Bergakademie, Freiberg, Germany describes SAP composites with bentonite (clay) to have water absorbance in excess of over 2000 gram/gram of the composite.

Bowling Green State University in the US has reported water absorbance in the range of 2000 to 6000 grams/gram of SAP. The research is described in Thilini K. Mudiyanselage et al, Highly Absorbing Superabsorbent Polymer, Journal of Polymer Science: Part A: Polymer Chemistry, Vol. 46, 1357-1364 (2008). The same research team at the Bowling Green State University has also synthesized photochromic SAPs with water absorbance of 2800 g/g of SAP. When the hydrated photochromic SAP was irradiated with UV light, it expelled the water.

Hitherto, no one has proposed use of SAPs for harvesting and storage of rain water.

### Advantages

Highly absorbent SAPs have now been developed with absorbency of more than 6000 times their weight of distilled water. With just 2000 g/g of absorbing capacity, we can have at 99.95% pure water in solid/gel form. Water in solid form can be easily transported and stored anywhere without leakage or loss. The solid water may be stored in cheap plastic bags for an extended period of time. The stored water in SAPs may be released at the point of use by any stimulus which may be mechanical, light-induced, electrical, thermal treatment, chemical treatment etc.

Accordingly, several advantages of one or more aspects of the invention are that looming worldwide water crisis can be solved with highly absorbent SAPs and water storage in SAPs may obviate the need to construct controversial huge dams and canals or drill wells. In arid lands, dew can be harvested and used to grow food to reduce hunger. Compared to 13,000 desalination plants worldwide, producing some 20 billion cu.m. of fresh water annually, equal amount of water can be obtained using only 200 plants each producing about 50,000 tonnes of SAP/year with 2000 g/g of absorbency.

Further advantages will become apparent from a consideration of the ensuing description.

### SUMMARY

In accordance with the invention, one or more aspects of water harvesting with SAPs are disclosed. Highly absorbent SAPs which are stimuli-responsive are used to harvest rain/dew water to augment water supply and solve water crisis. The SAPs may be recycled and rehydrated number of times. They may be an additional source for drinking water. The SAPs are used for storage of water in warehouses and may obviate the need to construct controversial huge dams and canals or drill wells. The stored water in SAPs is released at the point of use by any stimulus which may be mechanical, light-induced, electrical, thermal treatment, chemical treatment etc. Examples of SAPs include sodium or potassium salts of crosslinked polyacrylic acid, salts of crosslinked acrylamide copolymers, starch-acrylonitrile copolymers, composites with clay, stimuli-responsive polymers etc. SAPs with absorbing power of at least 1000 times their own weight are preferred. With 2000 g/g of swelling capacity, we can have 99.95% pure water in solid/gel form.

### DETAILED DESCRIPTION

SAPs are macromolecules that can absorb and retain extremely large amounts of a liquid relative to their mass. Lightly cross-linked sodium polyacrylate is the most common type of SAP made in the world today. Widely used in personal disposable hygiene products such as baby diapers, it can absorb up to about 800 times its weight of distilled water. Other SAP compositions include one derived from starch which is one of the oldest SAP developed.

No one has proposed for SAP's use for rain harvesting or water management. With just 2000 g/g of absorbing capacity, we can have 99.95% pure water in solid/gel form. Water in solid form can be easily transported and stored anywhere without leakage or loss. The solid water may be stored in cheap plastic bags for an extended period of time. Looming worldwide water crisis can be solved with highly absorbent SAPs. Water is oil of the future. Supplies of water are under enormous strain. About 75% of rainfall is lost due to runoff to sea Rain harvesting with SAPs and storage can augment water supplies and relieve crisis.

Water in solid/gel form can be transported to any remote part of the world in low-cost packages or transportation modes such as boxes, gunny bags, carts, open trucks etc. Water stored in SAPs is released at the point of use by an appropriate stimulus which may be mechanical, UV light, thermal treatment etc. The SAPs may be recycled and rehydrated number of times. They may be used for storage of water in warehouses and may obviate the need to construct controversial huge dams and canals or drill wells. An ultra SAP with absorbing capacity of 10,000 gram of water per gram of the polymer could hold 10 billion cu.m. of water in 1 (one) million tonnes of the polymer. This is more than the storage capacity of a typical large dam project over a river.

A typical supply cycle proposed is as follows: 1)Produce SAPs at strategic locations 2) Distribute SAP granules to harvesting centers 3) Harvest rain or dew with SAPs 4) Store hydrated SAPs 5) Transport hydrated SAPs to locations of use or water-pumping stations 6) Release water 7) Recycle used polymer. Alternately, individual homes or buildings fitted with commercial rain harvesting systems can augment their water supplies with SAPs.

SAPs can be made available in a variety of forms for harvesting purpose. These include granules, sheet-like structures, fibers and non-woven webs. Different types of techniques are described in literature for rain harvesting. These can be augmented with SAPs.

Specifically, rain water collected in catchment areas of rain harvesting systems such as tanks, paved or tiled fields etc are soaked into SAPs and hydrated SAPs stored. One example is use of sachets made of a non-woven fabric for SAP granules. Sachets of appropriate sizes partially filled with SAP granules are mechanically lowered or passed into rain catchment area. They are almost instantly hydrated with water and subsequently removed and stored. This whole operation can be mechanized.

Hydrated SAPs are stored in homes or warehouses. They may be transported to remote arid areas. At the point of use, hydrated SAPs are given an appropriate stimulus depending on the polymer type and water released. In one experiment, 0.5 gram of lightly cross-inked sodium polyacrylate was placed in a 12″×12″ sachet made of a non-woven fabric like one used for tea bags. The sachet was soaked in distilled water and it absorbed water instantly. Fully hydrated SAP weighed about 400 grams. About 2 c.c. of a saline solution was sprayed on the sachet. Most of the water was instantly released under slight hand pressure.

Dew can be a significant water source but it is lost via evaporation as soon as the sun comes up. In certain coastal arid regions of the world, dew occurs over a period of 8 months in a year. Dew water can be harvested using SAPs. In one method, granules of SAPs or sachets containing SAP are spread on a metal and/or plastic sheet, leaving them overnight and collecting hydrated SAP in the morning.

Accordingly, the reader will see that I have provided a solution to the looming worldwide water crisis by harvesting rain/dew water in SAPs. With just 2000 g/g of absorbing capacity of a highly absorbent SAP, we can have 99.95% pure water in solid/gel form. Water in solid form can be easily transported and stored anywhere without leakage or loss. The solid water may be stored in cheap plastic bags for an extended period of time. The stored water in SAPs may be released at the point of use by any stimulus which may be mechanical, light-induced, electrical, thermal treatment, chemical treatment etc. Water storage in SAPs may obviate the need to construct controversial huge dams and canals or drill wells. Starch-based highly absorbent SAP or a clay-composite may be made available at low cost for use of this invention. Compared to 13,000 desalination plants worldwide, producing some 20 billion cu.m. of fresh water annually, equal amount of water can be obtained using only 200 plants each producing about 50,000 tonnes of SAP/year with just 2000 g/g of water absorbency.

While the above description contains some specific examples, these should not be construed as limitations on the scope of the invention. Many other ramifications and variations are possible within the teachings of the invention. For example, instead of SAP granules in a sachet, SAP in the form of a sheet-like structure, fibers or fabric or the like may be used to harvest water. Instead of chemical stimulus shown in the above example, sun light or UV light may be used to release water from a hydrated photochromic SAP. Instead of water from rain or dew, SAPs may be used to harness water from fog or flood.

Thus the scope of the invention should be determined by the appended claims and their legal equivalents, and not by the examples given.

What is claimed is:

1. A method of harvesting rain water with superabsorbent polymers (SAPs), comprising absorbing water in a superabsorbent polymer, storing hydrated superabsorbent polymer, transporting hydrated superabsorbent polymer to point of use and releasing water from hydrated superabsorbent polymers with a stimulus.

2. A method of harvesting dew water with superabsorbent polymers, comprising absorbing water in superabsorbent polymer, storing hydrated superabsorbent polymer, transporting hydrated superabsorbent polymer to point of use and releasing water from hydrated superabsorbent polymer with a stimulus.

3. A method of claims 1 and 2 wherein superabsorbent polymer is used in the form granules or powder placed in fabric-based sachets partially filled with the polymer.

4. A method of claims 1 and 2 wherein superabsorbent polymer is used in the form of a sheet-like structure, fibers or fabric net or the like to absorb water

5. A method of absorbing dew water in superabsorbent polymers by spreading superabsorbent polymer powder/granules on a metal and/or a plastic sheet, leaving them overnight and collecting hydrated superabsorbent polymer in the morning.

6. A method for releasing stored water in hydrated superabsorbent polymers at point of use by a suitable technique which may involve mechanical, chemical, thermal, electrical, exposure to sun or UV light or other treatment.

7. Examples of superabsorbent polymers of claims 1 to 6 include sodium or potassium salts of crosslinked polyacrylic acid, salts of crosslinked acrylamide copolymers, starch-acrylonitrile copolymers, composites with clay, stimuli-responsive superabsorbent polymers such as photochromic or electroresponsive superabsorbent polymers etc.

8. Examples of superabsorbent polymers of claims 1 to 6 wherein the polymer particles are surface crosslinked to enhance water absorption.

9. Method of claims 1 to 6 wherein superabsorbent polymers are highly absorbent superabsorbent polymers with water retention of at least 1000 grams of water per gram of superabsorbent polymer.

10. Method of claims 1 and 2 wherein the entire process is adapted for a typical house- or a building- or community-based water harvesting system.

11. Method of claims 1 and 2 wherein the entire process is adapted for a typical farm.

12. Method of claims 1 and 2 wherein the water released is used for human drinking purposes.

13. Method of claims 1 and 2 wherein the entire process is adapted for harnessing water from flood or fog.
